(19) United States
(12) Patent Application Publication
(10) Pub. No.: US 2025/0192707 A1
(43) Pub. Date: Jun. 12, 2025

(54) CURRENT CONTROL METHOD AND MOTOR CONTROL CIRCUIT

(71) Applicant: JIANGSU DONGCHENG TOOLS TECHNOLOGY CO., LTD., Nantong (CN)

(72) Inventors: Haodong WANG, Nantong (CN); Jianan HUANG, Nantong (CN)

(21) Appl. No.: 19/052,401

(22) Filed: Feb. 13, 2025

Related U.S. Application Data
(62) Division of application No. 18/089,558, filed on Dec. 27, 2022, now Pat. No. 12,255,562.
Application No. 18/089,558 is a continuation of application No. PCT/CN2022/098288, filed on Jun. 11, 2022.

(30) Foreign Application Priority Data
Jul. 23, 2021 (CN) 202110835779.9

(51) Int. Cl. H02P 23/14; H02P 23/00; H02P 25/03

(52) U.S. Cl. CPC H02P 23/14; H02P 23/0004; H02P 25/03; H02P 2205/01; H02P 2209/11

(57) ABSTRACT

A motor control method and a motor control circuit. The motor control method includes: collecting a real-time current waveform of an AC power supply through a sampling circuit; obtaining a periodic voltage waveform signal of the AC power supply through a rectification circuit; obtaining a power frequency of the AC power supply by sampling the periodic voltage waveform signal multiple times; compensating the real-time current waveform and generating a target current waveform according to the power frequency; and controlling the motor according to the target current waveform. The rectification circuit includes: a first rectification circuit, a second rectification circuit, and a target capacitor; the first rectification circuit and the second rectification circuit are connected in parallel to two output ends of the AC power supply and configured to rectify the AC power supply; a controller is connected to an output end of the second rectification circuit.

### CROSS REFERENCE TO RELATED APPLICATIONS

The present application is a divisional application of U.S. patent application Ser. No. 18/089,558, which is a continuation-application of International (PCT) Patent Application No. PCT/CN2022/098288, filed on Jun. 11, 2022, which claims priority to Chinese Patent Application No. 202110835779.9 filed with China National Intellectual Property Administration on Jul. 23, 2021, the contents of which are herein incorporated by reference in their entireties.

### TECHNICAL FIELD

The present disclosure relates to technical field of motor control, in particular to a current control method and a motor control circuit.

### BACKGROUND

An existing alternating-current brushless circuit includes a large electrolytic capacitor, which makes motor control relatively simple. However, the large electrolytic capacitor usually has a large volume and a volume of a circuit board is thus increased. Therefore, in the current conventional scheme, a circuit does not include the large electrolytic capacitor to reduce the volume, and the circuit board has a long service life. However, since the circuit does not include the large electrolytic capacitor but include a capacitor with a small capacitance, a bus voltage is unstable after rectification. Therefore, an unstable working current leads to an unstable output power of the motor. In addition, for a tool that can be used in different alternating-current power supplies, when a correction value is introduced for a current, the tool needs to judge a power frequency. Since a bus waveform after rectification tends to fluctuate with the load, the correction value for the current is inaccurate, thereby affecting an operating performance of the tool.

### SUMMARY

A motor control method, including: collecting a real-time current waveform of an alternating current (AC) power supply through a sampling circuit; obtaining a periodic voltage waveform signal of the AC power supply through a rectification circuit; obtaining a power frequency of the AC power supply by sampling the periodic voltage waveform signal multiple times; compensating the real-time current waveform and generating a target current waveform according to the power frequency of the AC power supply; and controlling the motor according to the target current waveform. The rectification circuit includes: a first rectification circuit, a second rectification circuit, and a target capacitor, a capacitance value of the target capacitor being less than a preset capacity threshold; the first rectification circuit and the second rectification circuit are connected in parallel to two output ends of the AC power supply and configured to rectify the AC power supply; a controller is connected to an output end of the second rectification circuit through a voltage detection circuit; each of the two output ends of the AC power supply includes a neutral wire or a live wire.

A motor control circuit for controlling a motor to operate, the motor control circuit including: a rectification circuit, a driving circuit, a sampling circuit, and a controller; wherein the rectification circuit is connected to an alternating current (AC) power supply and the controller respectively, the rectification circuit comprising: a first rectification circuit and a second rectification circuit; the rectification circuit is connected in parallel between two output ends of the AC power supply for rectifying the AC power supply; an output end of the first rectification circuit is connected to the motor through the driving circuit; the sampling circuit is connected to the driving circuit; the controller is connected to an output end of the second rectification circuit through a voltage detection circuit. The motor control circuit is configured to perform: collecting a real-time current waveform of an alternating current (AC) power supply through a sampling circuit; obtaining a periodic voltage waveform signal of the AC power supply through a rectification circuit; obtaining a power frequency of the AC power supply by sampling the periodic voltage waveform signal multiple times; compensating the real-time current waveform and generating a target current waveform according to the power frequency of the AC power supply; wherein a fluctuation amplitude of the target current waveform is lower than a fluctuation amplitude of the real-time current waveform; and controlling the motor according to the target current waveform.

### BRIEF DESCRIPTION OF THE DRAWINGS

Specific embodiments of the present disclosure are further described in detail below in combination with drawings.

FIG. 1 is a schematic diagram of a control circuit of a current control method according to some embodiments of the present disclosure.

FIG. 2 is a schematic view of waveforms of a rectification input voltage and a rectification output voltage of a current control method according to some embodiments of the present disclosure.

FIG. 3 is a flowchart of a slope algorithm of a current control method according to some embodiments of the present disclosure.

FIG. 4 is a schematic diagram of a current-correction circuit of a control method according to some embodiments of the present disclosure.

Reference labels in the drawings.

First rectification circuit 1, second rectification circuit 2, driving circuit 3, motor 4, controller 5, logic operation unit 51, storage unit 52, timing unit 53, PWM generator 54, driving module 6, bus-current collecting unit 7, filter unit 8.

### DETAILED DESCRIPTION

The present disclosure is further described in detail below in combination with the drawings and embodiments.

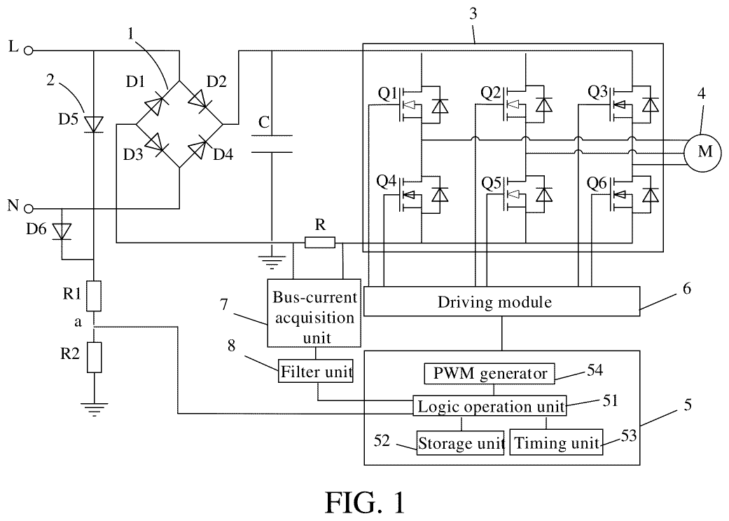

As shown in FIG. 1, a motor control circuit is provided in some embodiments of the present disclosure. The motor control circuit may include an alternating-current power supply, a first rectification circuit 1 and a second rectification circuit 2 which are connected in parallel between a live wire L of the alternating-current power supply and a neutral wire N of the alternating-current power supply and configured to rectify the alternating-current power supply. An output end of the first rectification circuit 1 is connected to a motor 4 through a driving circuit 3, and an output end of the second rectification circuit 2 is connected to a controller 5. The controller 5 is connected to the driving circuit 3 through a driving module 6 to drive the motor 4 to operate.

The first rectification circuit 1 is a bridge-type full wave rectification circuit constituted by connecting four diodes D1, D2, D3, and D4 for rectification end to end. The live wire L of the alternating-current power supply is connected to a negative pole of the diode D1 and a positive pole of the diode D2. A positive pole of the diode D1 is connected to a positive pole of diode D3 and then further connected to the driving circuit 3. A negative pole of diode D2 is connected to a negative pole of diode D4 and then further connected to the driving circuit 3. The neutral wire N of the alternating-current power supply is connected to a negative pole of diode D3 and a positive pole of diode D4. A capacitor C is connected in parallel between the output end of the first rectification circuit 1 and the driving circuit 3, and the capacitor C is grounded. A voltage input by the alternating-current power supply is full-wave rectified by the first rectification circuit 1, and the full-wave rectified voltage is input to the driving circuit 3 through the capacitor C. A current sampling resistor R is connected in series on a negative bus configured between the capacitor C and the driving circuit 3. A bus-current collecting unit 7 is connected at both ends of the current sampling resistor R, and is connected to the controller 5 through a filter unit 8. The bus-current collecting unit 7 is configured to collect a bus current value through the current sampling resistor R.

The second rectification circuit 2 may include a diode D5 and a diode D6 connected in parallel between the first rectification circuit 1 and the power supply. A positive pole of the diode D5 is connected to the live wire L of the alternating-current power supply, and a positive pole of the diode D6 is connected to the neutral wire N of the alternating-current power supply. Negative poles of the diode D5 and D6 are connected to each other, and are connected to the controller 5 through a voltage detection circuit.

The voltage detection circuit may include a first resistor R1 and a second resistor R2 connected in series. The other end of the first resistor R1 is connected to the output end of the second rectification circuit 2, a connection point of the first resistor R1 and the second resistor R2 is connected to the controller 5, and another end of the second resistor R2 is grounded. Since the voltage detection circuit and the capacitor C are grounded and equipotential, the first rectification circuit 1 shares the diodes D1 and D3 with the second rectification circuit 2. In this embodiment, a resistance value of the first resistor R1 is 750 KΩ, and a resistance value of the second resistor R2 is 6.8 KΩ, that is, a voltage collected at point a of the voltage detection circuit is a voltage value of the second resistor R2, such that the output voltage of the second rectification circuit 2 falls into a voltage range which is recognizable the controller 5.

The driving circuit 3 may include an upper bridge arm and a lower bridge arm, the upper bridge arm may include switch tubes Q1, Q2 and Q3, the lower bridge arm may include switch tubes Q4, Q5 and Q6, and each of the switch tubes is reversely connected in parallel with a diode. The motor 4 may be a brushless motor and include a three-phase winding. Each end of the three-phase winding is respectively connected to the corresponding connection points of the upper and lower bridge arms. The voltage input to the motor 4 may be controlled by turning on and turning off the switch tubes Q1 to Q6.

The controller 5 may include a logic operation unit 51, a storage unit 52 connected to the logic operation unit 51, a timing unit 53 connected to the logic operation unit 51, and a pulse width modulation (PWM) generator 54 connected to the logic operation unit 51.

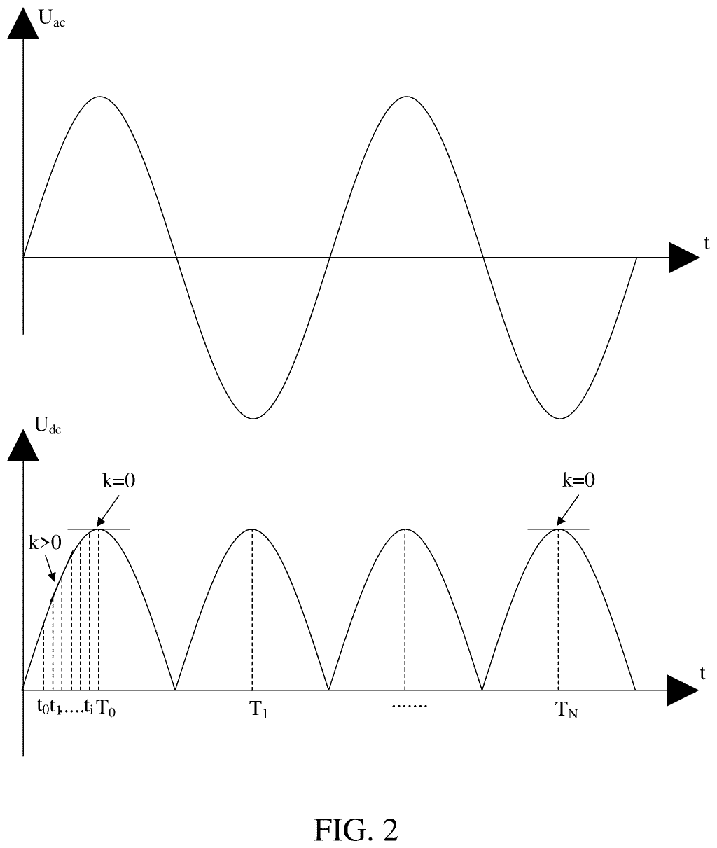

Generally, in order to reduce a volume of the circuit board, a capacitor with a small equivalent capacitance value is configured to filter. For example, in this embodiment, a capacitor C with an equivalent capacitance value of less than 15 uF is arranged in the circuit board. Therefore, when a load changes, a voltage output from the capacitor C varies according to or along with the load, resulting in waveform distortion. A standard periodic waveform signal of the bus voltage may be obtained by collecting the voltage of the second rectification circuit 2. As shown in FIG. 2, a waveform U_{ac} is an input voltage of the alternating-current power supply, and waveform U_{dc} is an output voltage of the second rectification circuit 2 which is output through the voltage detection circuit. The waveform corresponds to the bus voltage value in this embodiment, and the waveform does not vary according to or along with the load. Generally, a bus current varies according to a voltage. Therefore, the bus current needs to be compensated. A slope k is obtained by multiple samplings for the periodic waveform signal and linearly fitting a plurality of voltage values u obtained at a plurality of sampling time points t. Each of the slopes k corresponds to a phase φ of the periodic waveform signal. A power frequency f is obtained according to the slope k. The controller 5 calculates a compensation current value i_{comp} according to the power frequency f, generates a control signal according to the compensation current value i_{comp} and the bus current value i_{fdb}, and send the control signal to the PWM generator 54, to control the motor 4.

The controller 5 stores a voltage preset value. In response to the controller 5 detecting that the voltage value u is greater than the voltage preset value, the controller 5 is configured to start to collect each of the plurality of voltage values u corresponding to each of the sampling time points t. The logic operation unit 51 is configured to calculate each of the slopes k of the periodic waveform signal through linear fitting, and a formula for calculating each of the slopes k is k=E(t*u)−Et*Eu/E(t²)−(Et)². Herein, E(t*u) is a mathematical expectation of a product of a corresponding one the sampling time points t and a corresponding one the voltage values u, Et*Eu is a product of a mathematical expectation of the sampling time point t and a mathematical expectation of the corresponding one the voltage values u, E(t²) is a mathematical expectation of a square of the corresponding one the sampling time points t, and (Et)² is a square of the mathematical expectation of the corresponding one the sampling time points t.

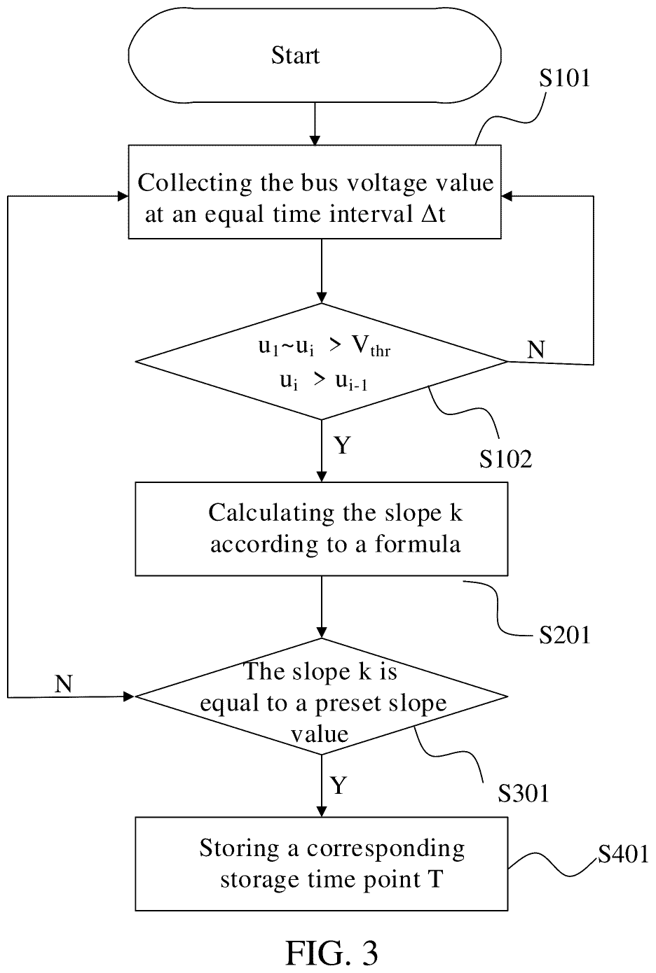

Specifically, the periodic waveform signal may be sampled within a preset sampling duration. As shown in FIGS. 2 and 3, calculation operations of the power supply frequency are as follows. Operation S101 may include: collecting the bus voltage value at an equal time interval Δt, and collecting the voltage value u of the periodic waveform signal at the sampling time point t. The sampling time points t may include or be defined as sampling time points t₀, t₁, t₂, . . . , t, and collected voltage values u₀, u₁, u₂, . . . , uᵢ correspond to the sampling time points t₀, t₁, t₂, . . . , t in one-to-one correspondence respectively, i indicates the number of sampling points, the time interval are defined as Δt, Δt=tᵢ₊₁−tᵢ, the time intervals Δt are the same as or equal to each other. Operation S102 may include: in response to detecting that a voltage value uᵢ corresponding to the periodic waveform signal at a current sampling time point t is greater than a voltage value uᵢ₋₁ corresponding to the periodic waveform signal at a previous sampling time point t relative to the sampling time point t, and each of the voltage values u (including u₁˜uᵢ) is greater than a preset voltage threshold Vₜₕᵣ, that is, in response to detecting uᵢ>uᵢ₋₁ and uᵢ˜uᵢ>Vₜₕᵣ, starting to collect each of the voltage values u corresponding to the each of the sampling time points t, and calculate each of the slopes k. Operation S201 may include: calculating each of the slopes k according to a formula

$$k = [ n ⋆ {\sum }_{i = 0}^{n - 1} ( ti * ui ) \to {\sum }_{i = 0}^{n - 1} ti * {\sum }_{i = 0}^{n - 1} ui ] / [ n * {\sum }_{i = 0}^{n - 1} {ti}^{2} - {\sum }_{i = 0}^{n - 1} t i * {\sum }_{i = 0}^{n - 1} ti ] .$$

Herein, n is a positive integer greater than 1, i=0, 1, 2, . . . n−1, Σᵢ₌₀ⁿ⁻¹(ti*ui) indicates a sum of a product of tᵢ and uᵢ of each of n sampling points, Σᵢ₌₀ⁿ⁻¹ti*Σᵢ₌₀ⁿ⁻¹ui includes n sample points and indicates a product of a sum of each tᵢ and a sum of each uᵢ, Σᵢ₌₀ⁿ⁻¹ti² includes n sampling points and indicates a sum of a square of each tᵢ, Σᵢ₌₀ⁿ⁻¹ti*Σᵢ₌₀ⁿ⁻¹ti includes n sampling points and indicates a square of a sum of ti. In order to further reduce a calculation overhead of software, the positive integer n=2^{m}, and m is a positive integer. Operation S301 may include: determining whether the slope k is equal to a preset slope value. The controller 5 stores the preset slope value. In this embodiment, the preset slope value is 0, that is, a phase of a corresponding periodic waveform signal is 90°. In other embodiments, the preset slope value may be any value. Operation S401 may include: in response to determining that the slope k is equal to the preset slope value, storing a corresponding storage time point T; in response to determining that the slope k is not equal to the preset slope value, returning to operation S101 and performing the determination process again. The multiple samplings are performed according to above operations to obtain N time points at which the slope k is equal to the preset slope value. A time point at which a corresponding slope k being equal to the preset slope value is obtained for the first time is a starting time point defined as T₀, and a time point at which the Nth slope k being equal to the preset slope value is obtained is a final time point defined as T_{N}. The final time point T_{N} is the time point at which the periodic waveform signal is N times of 90°. A periodic duration defined as Tₚ and is calculated according to a formula Tₚ=(T_{N}−T₀)/N. The controller 5 obtains the power frequency f by calculating a reciprocal of the periodic duration.

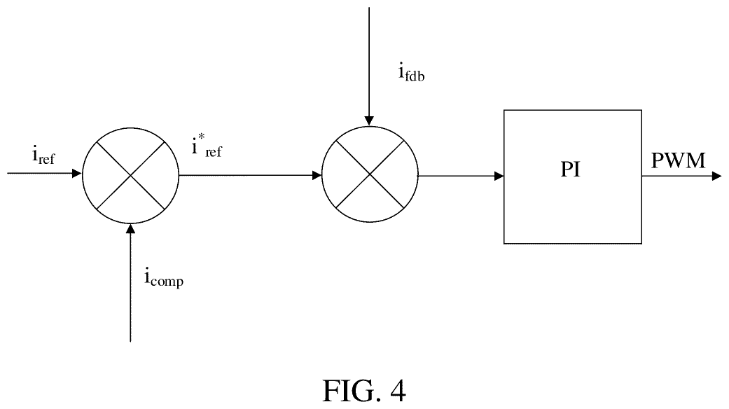

As shown in FIG. 4, FIG. 4 is a schematic diagram of a current-correction circuit. The controller 5 stores a capacitance value of the capacitor C, and calculates the compensation current value i_{comp}, by a formula, according to the voltage value u and the power frequency f. The formula for calculating the compensation current value icₒₘₚ is \sqrt{2}C_{dc}Uωᵢₙ cos(ωᵢₙt) sign (sin(ωᵢₙt)). Herein, C_{dc} is the capacitance value, U is an effective value of a sampled voltage u, ω_{In} is an angular frequency of the power supply, ω_{In} is equal to 2πf, and sign is a symbolic function. The controller 5 stores a target current reference value i_{ref}, and a correction current reference value i*re_{f} is obtained by subtracting the compensation current value i_{comp} from the target current reference value i_{ref}. PI (proportional integral) control processing is performed on the bus current value i_{fdb} and the correction current reference value i*_{ref} to obtain the control signal. The controller 5 changes the duty ratio according to the control signal to drive motor 4. By changing the compensation current value i_{comp} in real time, the current can be compensated in real time with a phase change of the periodic waveform signal to ensure stability of the bus current, thereby stabilizing output power.

A current control method performed by a motor control circuit for controlling a motor to operate is provided. The motor control circuit includes a power supply including a live wire and a natural wire; a first rectification circuit and a second rectification circuit connected in parallel between a live wire of the power supply and a neutral wire of the power supply and configured to rectify the power supply. The motor control circuit further includes a driving circuit, an output end of the first rectification circuit being connected to the motor through the driving circuit, and a sampling resistor being connected to the driving circuit. The motor control circuit further includes a sampling resistor connected to the driving circuit, and a controller connected to an output end of the second rectification circuit through a voltage detection circuit. the current control method includes: obtaining, by the controller, a periodic waveform signal of a bus voltage; collecting, by the controller, a bus current value through the sampling resistor; sampling, by the controller, the periodic waveform signal for a plurality of times; linearly fitting, by the controller, a plurality of voltage values obtained at a plurality of sampling time points to obtain a plurality of slopes; obtaining a power frequency according to the plurality of slopes; calculating, by the controller, a compensation current value according to the power frequency; and generating a control signal according to the compensation current value and the bus current value to control the motor.

In some embodiments, the voltage detection circuit includes a first resistor and a second resistor in series, the other end of the first resistor is connected to the output end of the second rectification circuit, a connection point of the first resistor and the second resistor is connected to the controller, and the other end of the second resistor is grounded.

In some embodiments, the output end of the first rectification circuit is connected to the driving circuit through a capacitor connected in parallel, and an end of the capacitor is grounded; the first rectification circuit includes four diodes, and two diodes of the first rectification circuit are shared with the second rectification circuit.

In some embodiments, the controller stores a voltage preset value, and the controller is configured to start to collect each of the plurality of voltage values corresponding to each of the sampling time points in response to the controller detecting that each of the voltage values is greater than the voltage preset value.

In some embodiments, the controller includes a logic operation unit, and the logic operation unit is configured to calculate each of the slopes of the periodic waveform signal through linear fitting; a formula for calculating each of the slopes is

$$k = \frac{E ( t * u ) - Et * Eu}{{E ( {t}^{3} ) - Et )}^{2}} ;$$

t is a sampling time point; u is a voltage value; k is a slope; E(t*u) is a mathematical expectation of a product of a corresponding one of the sampling time points and a corresponding one of the voltage values; Et*Eu is a product of a mathematical expectation of the corresponding one the sampling time points and a mathematical expectation of the corresponding one the voltage values; E(t²) is a mathematical expectation of a square of the corresponding one the sampling time points; and (Et)² is a square of a mathematical expectation of the corresponding one the sampling time points.

In some embodiments, the sampling time points include sampling time points defined as t₀, t₁, t₂, . . . , t, the voltage value includes voltage values defined as u₀, u₁, u₂, . . . , uᵢ, and the sampling time points t₀, t₁, t₂, . . . , t correspond to voltage values u₀, u₁, u₂, . . . , uᵢ in one-to-one correspondence respectively; i indicates the number of sampling points, time intervals are defined as Δt, Δt=tᵢ₊₁−tᵢ, and the time intervals Δt are equal to each other.

In some embodiments, the logic operation unit is configured to calculate each of the slopes of the periodic waveform signal through linear fitting, and the formula for calculating each of the slopes is

$$k = [ n ⋆ {\sum }_{i = 0}^{n - 1} ( ti * ui ) \to {\sum }_{i = 0}^{n - 1} ti * {\sum }_{i = 0}^{n - 1} ui ] / [ n * {\sum }_{i = 0}^{n - 1} {ti}^{2} - {\sum }_{i = 0}^{n - 1} t i * {\sum }_{i = 0}^{n - 1} ti ] ,$$

n is a positive integer greater than 1.

In some embodiments, the controller stores a preset slope value; a time point at which a corresponding slope being equal to the preset slope value is obtained for the first time is a starting time point defined as T₀, and a time point at which the Nth slope being equal to the preset slope value is obtained is a final time point defined as T_{N}; a periodic time defined as Tₚ and is calculated according to a formula Tₚ=(T_{N}−T₀)/N; and the controller is configured to obtain the power frequency by calculating a reciprocal of the periodic time.

In some embodiments, the preset slope value is 0, the starting time point is a time point at which the periodic waveform signal is 90°, and the final time point is time point at which the periodic waveform signal is N times of 90°.

In some embodiments, the controller stores a capacitance value of the capacitor, and is configured to calculate the compensation current value, by a formula, according to the voltage value and the power frequency. The formula for calculating the compensation current value is \sqrt{2}C_{dc}Uωᵢₙ cos(ωᵢₙt) sign (sin(ωᵢₙt)), C_{dc} is a capacitance value; U is an effective value of a sampled voltage; ω_{In} is an angular frequency of the power supply; and sign is a symbolic function.

In some embodiments the controller stores a target current reference value, a correction current reference value is obtained by subtracting the compensation current value from the target current reference value, a proportional integral control processing is performed on the bus current value and the correction current reference value to obtain the control signal, and the controller is configured to changes a duty ratio according to the control signal to drive the motor.

A motor control circuit for controlling a motor to operate is provided and includes a power supply including a live wire and a natural wire; a first rectification circuit and a second rectification circuit, connected in parallel between the live wire of the power supply and the natural wire of the power supply and configured to rectify the power supply; a driving circuit, an output end of the first rectification circuit is connected to the motor through the driving circuit; a sampling resistor connected to the driving circuit; and a controller connected to an output end of the second rectification circuit through a voltage detection circuit, the controller is configured to: obtain a periodic waveform signal of a bus voltage; collect a bus current value through the sampling resistor; sample the periodic waveform signal for a plurality of times; linearly fit a plurality of voltage values obtained at a plurality of sampling time points t to obtain a plurality of slopes; obtain a power frequency f according to the plurality of slopes; calculate a compensation current value according to the power frequency; and generate a control signal according to the compensation current value and the bus current value to control the motor.

In some embodiments, the voltage detection circuit includes a first resistor and a second resistor connected in series, the other end of the first resistor is connected to the output end of the second rectification circuit, a connection point of the first resistor and the second resistor is connected to the controller, and the other end of the second resistor is grounded.

In some embodiments, the output end of the first rectification circuit is connected to the driving circuit through a capacitor connected in parallel, and an end of the capacitor is grounded; the first rectification circuit includes four diodes, and two diodes of the first rectification circuit are shared with the second rectification circuit.

In some embodiments, the first rectification circuit is a bridge-type full wave rectification circuit constituted by connecting a first diode, a second diode, a third diode, and a fourth diode for rectification end to end, the live wire is connected to a negative pole of the first diode and a positive pole of the second diode, a positive pole of the first diode is connected to a positive pole of the third diode and then further connected to the driving circuit, a negative pole of the second diode is connected to a negative pole of the fourth diode and then further connected to the driving circuit, the neutral wire is connected to a negative pole of the third diode and a positive pole of the fourth diode; a voltage input by the power supply is full-wave rectified by the first rectification circuit, and the full-wave rectified voltage is input to the driving circuit through the capacitor, a current sampling resistor is connected in series on a negative bus configured between the capacitor and the driving circuit, a bus-current collecting unit is connected at both ends of the current sampling resistor and is connected to the controller through a filter unit, the bus-current collecting unit is configured to collect a bus current value through the current sampling resistor.

In some embodiments, the second rectification circuit include a fifth diode and a sixth diode connected in parallel between the first rectification circuit and the power supply, a positive pole of the fifth diode is connected to the live wire, and a positive pole of the sixth diode is connected to the neutral wire, negative poles of the fifth diode and the sixth diode are connected to each other and are connected to the controller through the voltage detection circuit.

In some embodiments, the controller stores a voltage preset value, and the controller is configured to start to collect each of the plurality of voltage values corresponding to each of the sampling time points in response to the controller detecting that each of the voltage values is greater than the voltage preset value.

In some embodiments, the controller includes a logic operation unit, and the logic operation unit is configured to calculate each of the slopes of the periodic waveform signal through linear fitting; a formula for calculating each of the slopes is

$$k = \frac{E ( t * u ) - Et * Eu}{{E ( {t}^{2} ) - Et )}^{2}} ;$$

t is a sampling time point; u is a voltage value; k is a slope; E(t*u) is a mathematical expectation of a product of a corresponding one of the sampling time points and a corresponding one of the voltage values; Et*Eu is a product of a mathematical expectation of the corresponding one of the sampling time points and a mathematical expectation of the corresponding one of the voltage values; E(t²) is a mathematical expectation of a square of the corresponding one of the sampling time points; and(Et)² is a square of a mathematical expectation of the corresponding one of the sampling time points.

In some embodiments, the sampling time points include sampling time points defined as t₀, t₁, t₂, . . . , t, the voltage value includes voltage values defined as u₀, u₁, u₂, . . . , uᵢ, and the sampling time points t₀, t₁, t₂, . . . , t correspond to voltage values u₀, u₁, u₂, . . . , uᵢ in one-to-one correspondence respectively; i indicates the number of sampling points, time intervals are defined as Δt, Δt=tᵢ₊₁−tᵢ, and the time intervals Δt are equal to each other.

A motor control circuit for controlling a brushless motor is provided and includes a power supply including a live wire and a natural wire; a first rectification circuit, connected in parallel between the live wire of the power supply and the natural wire of the power supply, configured to rectify the power supply and including an output end connected to a driving circuit through a capacitor connected in parallel to the driving circuit, the driving circuit is further connected to the brushless motor, and the capacitor has an equivalent capacitance value of less than 15 uF; a second rectification circuit, connected in parallel between the live wire of the power supply and the natural wire of the power supply, and configured to rectify the power supply; a sampling resistor, connected to the driving circuit; and a controller, connected to an output end of the second rectification circuit through a voltage detection circuit, and configured to compensate a bus current and control the brushless motor by using the compensated bus current.

In the current control method for controlling a motor to operate in some embodiments of the present disclosure, two rectification circuits are arranged, the periodic waveform signal of the bus voltage are obtained from the front rectification circuit, and the power frequency f are obtained through linear fitting. The controller 5 calculates the compensation current value i_{comp} according to the power frequency f, obtains the reference value i*ᵣₑf of the correction current, and generates the control signal by comparing the reference value i*ᵣₑf with the bus current value i_{fdb} to control the motor 4. Therefore, a relatively stable bus voltage may be collected even if a non-polar capacitor is used, and the bus current may be accurately corrected, thereby stabling the output power.

The present disclosure is not limited to above specific embodiments. Those skilled can easily understand that there are many other alternatives to the current control methods of the present disclosure without departing from the principle and scope of the present disclosure. The scope of the present disclosure is subject to the claims.

What is claimed is:

1. A motor control method, comprising:
collecting a real-time current waveform of an alternating current (AC) power supply through a sampling circuit;
obtaining a periodic voltage waveform signal of the AC power supply through a rectification circuit;
obtaining a power frequency of the AC power supply by multi-sampling the periodic voltage waveform signal;
compensating the real-time current waveform and generating a target current waveform according to the power frequency of the AC power supply; and
controlling the motor according to the target current waveform;
wherein the rectification circuit comprises: a first rectification circuit, a second rectification circuit, and a target capacitor, a capacitance value of the target capacitor being less than a preset capacity threshold;
the first rectification circuit and the second rectification circuit are connected in parallel to two output ends of the AC power supply and configured to rectify the AC power supply;
a controller is connected to an output end of the second rectification circuit through a voltage detection circuit; each of the two output ends of the AC power supply comprises a neutral wire or a live wire.

2. The method according to claim 1, wherein the generating a target current waveform comprises:
obtaining a target current compensation value according to the power frequency and the real-time current waveform;
obtaining a preset current value of the AC power supply;
obtaining a target current reference value according to the preset current value and the target current compensation value and
inputting the target current reference value and the real-time current waveform into the controller to generate the target current waveform, for suppressing a peak value of the real-time current waveform from being greater than a preset current threshold.

3. The method according to claim 2, wherein the obtaining a target current compensation value comprises:
obtaining the capacitance value of the target capacitor, a voltage sampling value of the AC power supply, and the power frequency of the AC power supply; and
calculating and obtaining a target current compensation value according to the capacitance value of the target capacitor, the voltage sampling value of the AC power supply, and the power frequency of the AC power supply.

4. The method according to claim 3, wherein the calculating and obtaining a target current compensation value comprise:
calculating and obtaining the target current compensation value by a target formula:
$${I}_{c o m p} = \sqrt{2} {C}_{d c} U {ω}_{i n} cos ( {ω}_{i n} t ) sign ( sin ( {ω}_{in} t ) ;$$
wherein C_{dc} is the capacitance value;
U is an effective value of the voltage sampling value;
ωᵢₙ is an angular frequency of the AC power supply;
t is a sampling time point; and
sign is a symbolic function.

5. The method according to claim 1, wherein the obtaining a power frequency of the AC power supply comprises:
obtaining a sampling result of the periodic voltage waveform signal;
according to the sampling result of the periodic voltage waveform signal, performing a linear fitting of voltage values obtained at a plurality of sampling time points, and obtaining a slope of the periodic voltage waveform signal; and
obtaining the power frequency according to the slope of the periodic voltage waveform signal;
wherein the obtaining a sampling result of the periodic voltage waveform signal comprises:
obtaining a preset voltage value of the AC power supply; and
in response to a voltage value of the periodic voltage waveform signal at a current moment being greater than the preset voltage value, obtaining the voltage value at the current moment.

6. The method according to claim 5, wherein the obtaining a slope of the periodic voltage waveform signal comprises:
calculating and obtaining each slope of the periodic voltage waveform signal by linear fitting; wherein each slope is calculated by a formula;
$$k = \frac{E ( t * u ) - Et * Eu}{{E ( {t}^{2} ) - Et )}^{2}} ;$$
wherein t is a sampling time point; u is a voltage value; k is a slope;
E(t*u) is a mathematical expectation of a product of a corresponding one of the sampling time points and a corresponding one of the voltage values;
Et*Eu is a product of a mathematical expectation of the corresponding one of the sampling time points and a mathematical expectation of the corresponding one of the voltage values;
E(t²) is a mathematical expectation of a square of the corresponding one of the sampling time points; and
(Et)² is a square of a mathematical expectation of the corresponding one of the sampling time points.

7. The method according to claim 6, wherein the sampling time points comprise sampling time points defined as t₀, t₁, t₂, . . . , t, the voltage value comprises voltage values defined as u₀, u₁, u₂, . . . , uᵢ, and the sampling time points t₀, t₁, t₂, . . . , t correspond to voltage values u₀, u₁, u₂, . . . , uᵢ in one-to-one correspondence respectively;
i indicates the number of sampling points, time intervals are defined as Δt, Δt=tᵢ₊₁−tᵢ, and the time intervals Δt are equal to each other.

8. The method according to claim 7, wherein each slope is calculated by a formula:
$$k = [ n ⋆ {\sum }_{i = 0}^{n - 1} ( ti * ui ) \to {\sum }_{i = 0}^{n - 1} ti * {\sum }_{i = 0}^{n - 1} ui ] / [ n * {\sum }_{i = 0}^{n - 1} {ti}^{2} - {\sum }_{i = 0}^{n - 1} t i * {\sum }_{i = 0}^{n - 1} ti ] ;$$
wherein n is a positive integer greater than 1.

9. The method according to claim 5, wherein the controller stores a preset slope value; a time point at which a corresponding slope being equal to the preset slope value is obtained for the first time is a starting time point defined as T₀, a time point at which the Nth slope being equal to the preset slope value is obtained is a final time point defined as T_{N}, a periodic duration defined as Tₚ and is calculated according to a formula Tₚ=(T_{N}−T₀)/N, and the controller is configured to obtain the power frequency by calculating a reciprocal of the periodic duration.

10. The method according to claim 9, wherein the preset slope value is 0, the starting time point is a time point at which the periodic waveform signal is 90°, and the final time point is time point at which the periodic waveform signal is N times of 90°.

11. A motor control circuit for controlling a motor to operate, the motor control circuit comprising:
a rectification circuit, a driving circuit, a sampling circuit, and a controller;
wherein the rectification circuit is connected to an alternating current (AC) power supply and the controller respectively, the rectification circuit comprising: a first rectification circuit and a second rectification circuit;
the rectification circuit is connected in parallel between two output ends of the AC power supply for rectifying the AC power supply;
an output end of the first rectification circuit is connected to the motor through the driving circuit;
the sampling circuit is connected to the driving circuit;
the controller is connected to an output end of the second rectification circuit through a voltage detection circuit;
wherein the motor control circuit is configured to perform:
collecting a real-time current waveform of an alternating current (AC) power supply through a sampling circuit;
obtaining a periodic voltage waveform signal of the AC power supply through a rectification circuit;
obtaining a power frequency of the AC power supply by sampling the periodic voltage waveform signal multiple times;
compensating the real-time current waveform and generating a target current waveform according to the power frequency of the AC power supply; wherein a fluctuation amplitude of the target current waveform is lower than a fluctuation amplitude of the real-time current waveform; and
controlling the motor according to the target current waveform.

12. The motor control circuit according to claim 11, wherein the generating a target current waveform comprises:
obtaining a target current compensation value according to the power frequency and the real-time current waveform;
obtaining a preset current value of the AC power supply;
obtaining a target current reference value according to the preset current value and the target current compensation value; and
inputting the target current reference value and the real-time current waveform into the controller to generate the target current waveform.

13. The motor control circuit according to claim 11, wherein the obtaining a target current compensation value comprises:
obtaining the capacitance value of the target capacitor, a voltage sampling value of the AC power supply, and the power frequency of the AC power supply; and
calculating and obtaining a target current compensation value according to the capacitance value of the target capacitor, the voltage sampling value of the AC power supply, and the power frequency of the AC power supply.

14. The motor control circuit according to claim 13, wherein the calculating and obtaining a target current compensation value comprise:
calculating and obtaining the target current compensation value by a target formula:
$${I}_{c o m p} = \sqrt{2} {C}_{d c} U {ω}_{i n} cos ( {ω}_{i n} t ) sign ( sin ( {ω}_{in} t ) ;$$
wherein C_{dc} is the capacitance value;
U is an effective value of the voltage sampling value;
ωᵢₙ is an angular frequency of the AC power supply;
t is a sampling time point; and
sign is a symbolic function.

15. The motor control circuit according to claim 11, wherein the obtaining a power frequency of the AC power supply comprises:
obtaining a sampling result of the periodic voltage waveform signal;
according to the sampling result of the periodic voltage waveform signal, performing a linear fitting of voltage values obtained at a plurality of sampling time points, and obtaining a slope of the periodic voltage waveform signal; and
obtaining the power frequency according to the slope of the periodic voltage waveform signal;
wherein the obtaining a sampling result of the periodic voltage waveform signal comprises:
obtaining a preset voltage value of the AC power supply; and
in response to a voltage value of the periodic voltage waveform signal at a current moment being greater than the preset voltage value, obtaining the voltage value at the current moment.

16. The motor control circuit according to claim 15, wherein the sampling time points comprise sampling time points defined as t₀, t₁, t₂, . . . , t, the voltage value comprises voltage values defined as u₀, u₁, u₂, . . . , uᵢ, and the sampling time points t₀, t₁, t₂, . . . , t correspond to voltage values u₀, u₁, u₂, . . . , uᵢ in one-to-one correspondence respectively;
i indicates the number of sampling points, time intervals are defined as Δt, Δt=tᵢ₊₁−tᵢ, and the time intervals Δt are equal to each other;
wherein each slope is calculated by a formula:
$$k = [ n ⋆ {\sum }_{i = 0}^{n - 1} ( ti * ui ) \to {\sum }_{i = 0}^{n - 1} ti * {\sum }_{i = 0}^{n - 1} ui ] / [ n * {\sum }_{i = 0}^{n - 1} {ti}^{2} - {\sum }_{i = 0}^{n - 1} t i * {\sum }_{i = 0}^{n - 1} ti ] ;$$
wherein n is a positive integer greater than 1.

17. The motor control circuit according to claim 11, wherein the voltage detection circuit comprises a first resistor and a second resistor connected in series, the other end of the first resistor is connected to the output end of the second rectification circuit, a connection point of the first resistor and the second resistor is connected to the controller, and the other end of the second resistor is grounded.

18. The motor control circuit according to claim 11, wherein the output end of the first rectification circuit is connected to the driving circuit through a capacitor connected in parallel, and an end of the capacitor is grounded; the first rectification circuit comprises four diodes, and two diodes of the first rectification circuit are shared with the second rectification circuit.

19. The motor control circuit according to claim 11, wherein the first rectification circuit is a bridge-type full wave rectification circuit comprising a first diode, a second diode, a third diode, and a fourth diode connected end to end; the live wire is connected to a negative pole of the first diode and a positive pole of the second diode; a positive pole of the first diode is connected to a positive pole of the third diode and further connected to the driving circuit; a negative pole of the second diode is connected to a negative pole of the fourth diode and further connected to the driving circuit; the neutral wire is connected to a negative pole of the third diode and a positive pole of the fourth diode;
a current sampling resistor is connected in series to a negative bus configured between the capacitor and the driving circuit; the current sampling resistor is connected to a bus-current collecting unit at both ends of the current sampling resistor and is connected to the controller through a filter unit; the bus-current collecting unit is configured to collect a bus current value through the current sampling resistor.

20. The motor control circuit according to claim 11, wherein the second rectification circuit comprises:
a fifth diode and a sixth diode connected in parallel between the first rectification circuit and the AC power supply; a positive pole of the fifth diode is connected to the live wire, and a positive pole of the sixth diode is connected to the neutral wire; a negative pole of the fifth diode and a negative pole the sixth diode are connected to each other and connected to the controller through a voltage detection circuit.
